(19) United States
(12) Patent Application Publication
(10) Pub. No.: US 2023/0398693 A1
(43) Pub. Date: Dec. 14, 2023

(54) Robotic Arm System

(71) Applicant: Black-I Robotics, Inc., Tyngsboro, MA (US)

(72) Inventors: Brian T. Hart, Bedford, MA (US); Mischa deRuijter, Harvard, MA (US); David Askey, Salem, MA (US)

(21) Appl. No.: 18/189,070

(22) Filed: Mar. 23, 2023

Related U.S. Application Data
(63) Continuation-in-part of application No. 17/111,898, filed on Dec. 4, 2020.
(60) Provisional application No. 63/323,369, filed on Mar. 24, 2022.
(60) Provisional application No. 62/974,359, filed on Dec. 4, 2019.
(60) Provisional application No. 63/102,469, filed on Jun. 15, 2020.

(51) Int. Cl. B25J 9/16; B25J 9/04; B25J 13/00; B25J 19/00; B25J 19/02

(52) U.S. Cl. CPC B25J 9/1697; B25J 9/046; B25J 19/023; B25J 9/162; B25J 19/0025; B25J 13/003

(57) ABSTRACT

A self-contained robotic arm system includes: an operating platform; a robotic arm subsystem coupled to the operating platform; a control subsystem coupled to the operating platform and configured to effectuate movement of the robotic arm assembly; a mast assembly coupled to and configured to rotate with the robotic arm subsystem; and a machine vision system coupled to the mast assembly and configured to enable a user of the self-contained robotic arm system to visually monitor areas proximate the self-contained robotic arm system.

### RELATED APPLICATION(S)

This application claims the benefit of U.S. Provisional Application No. 63/323,369, filed on 24 Mar. 2022. This application is also a Continuation-in-Part of U.S. utility application Ser. No. 17/111,898, filed on 4 Dec. 2020, which claims the benefit of U.S. Provisional Application No. 63/102,469, filed on 15 Jun. 2020, and U.S. Provisional Application No. 62/974,359, filed on 4 Dec. 2019, their entire contents of which are incorporated herein by reference.

### TECHNICAL FIELD

This disclosure relates to robotic arms and, more particularly, to self-contained robotic arms.

### BACKGROUND

Robotic arms are used in industry to automate tasks. For example, such robotic arms may be used to pick up objects, assembly cars, weld metal, machine material, lift heavy objects, and repeatedly perform redundant tasks. As such robotic arms tend to be heavy, they tend to be permanently mounted to rigid bases. For example, such robotic arms may be mounted to a cement base that is proximate an assembly line.

Unfortunately, such a configuration results in robotic arms that are essentially non-moveable. While these robotic arms may be removed from their rigid base to be relocated, it is a complicated process because a new rigid base would need to be constructed and new data and power connections would need to be plumbed.

### SUMMARY OF DISCLOSURE

In one implementation, a self-contained robotic arm system includes: an operating platform; a robotic arm subsystem coupled to the operating platform; a control subsystem coupled to the operating platform and configured to effectuate movement of the robotic arm assembly; a mast assembly coupled to and configured to rotate with the robotic arm subsystem; and a machine vision system coupled to the mast assembly and configured to enable a user of the self-contained robotic arm system to visually monitor areas proximate the self-contained robotic arm system.

One or more of the following features may be included. The machine vision system may include: a LIDAR system; and a plurality of discrete machine vision cameras configured to provide a plurality of discrete machine vision fields of view. At least of portion of the plurality of discrete machine vision fields of view may be configured to overlap to reduce/eliminate blind spots proximate the self-contained robotic arm system. An audio system may be coupled to the mast assembly and may be configured to enable a user of the self-contained robotic arm system to audibly monitor areas proximate the self-contained robotic arm system. The control subsystem may include one or more of: a pneumatic control subsystem; a electric control subsystem; and a hydraulic control subsystem. The pneumatic control subsystem may include one or more of: pneumatic controls; one or more pneumatic actuators; an air compressor; and an air storage tank. The electric control subsystem may include one or more of: electronic controls; and one or more electronic actuators. The hydraulic control subsystem may include one or more of: hydraulic controls; one or more hydraulic actuators; a hydraulic pump; and a hydraulic fluid storage tank. The robotic arm subsystem may include one or more of: an arm base assembly; a shoulder joint assembly coupled to the arm base assembly; an upper arm assembly coupled to the should joint assembly; an elbow joint assembly coupled to the upper arm assembly; a lower arm assembly coupled to the elbow joint assembly; a wrist joint assembly coupled to the lower arm assembly; and a gripper assembly coupled to the wrist joint assembly. The mast assembly may be coupled to the arm base assembly of the robotic arm subsystem. The shoulder joint assembly may be configured to enable rotation about one or more of the X, Y and Z axis. The elbow joint assembly may be configured to enable rotation about one or more of the X, Y and Z axis. The wrist joint assembly may be configured to enable rotation about one or more of the X, Y and Z axis. The operating platform may be a moveable operating platform. The moveable operating platform may include one or more of: an autonomous mobile base; a non-autonomous mobile base; a forklift; and a truck.

In another implementation, a self-contained robotic arm system includes: an operating platform; a robotic arm subsystem coupled to the operating platform; a control subsystem coupled to the operating platform and configured to effectuate movement of the robotic arm assembly; a mast assembly coupled to and configured to rotate with the robotic arm subsystem; and a machine vision system coupled to the mast assembly and configured to enable a user of the self-contained robotic arm system to visually monitor areas proximate the self-contained robotic arm system, wherein the machine vision system includes: a plurality of discrete machine vision cameras configured to provide a plurality of discrete machine vision fields of view.

One or more of the following features may be included. The machine vision system further may include: a LIDAR system. At least of portion of the plurality of discrete machine vision fields of view may be configured to overlap to reduce/eliminate blind spots proximate the self-contained robotic arm system. An audio system may be coupled to the mast assembly and may be configured to enable a user of the self-contained robotic arm system to audibly monitor areas proximate the self-contained robotic arm system. The robotic arm subsystem may include one or more of: an arm base assembly; a shoulder joint assembly coupled to the arm base assembly; an upper arm assembly coupled to the should joint assembly; an elbow joint assembly coupled to the upper arm assembly; a lower arm assembly coupled to the elbow joint assembly; a wrist joint assembly coupled to the lower arm assembly; and a gripper assembly coupled to the wrist joint assembly. The mast assembly may be coupled to the arm base assembly of the robotic arm subsystem.

In another implementation, a self-contained robotic arm system includes: an operating platform; a robotic arm subsystem coupled to the operating platform; a control subsystem coupled to the operating platform and configured to effectuate movement of the robotic arm assembly; a mast assembly coupled to and configured to rotate with the robotic arm subsystem; and a machine vision system coupled to the mast assembly and configured to enable a user of the self-contained robotic arm system to visually monitor areas proximate the self-contained robotic arm system, wherein the machine vision system includes: a plurality of discrete machine vision cameras configured to provide a plurality of discrete machine vision fields of view, and a LIDAR system; wherein a least of portion of the plurality of discrete machine vision fields of view are configured to overlap to reduce/eliminate blind spots proximate the self-contained robotic arm system.

One or more of the following features may be included. An audio system may be coupled to the mast assembly and may be configured to enable a user of the self-contained robotic arm system to audibly monitor areas proximate the self-contained robotic arm system. The robotic arm subsystem may include one or more of: an arm base assembly; a shoulder joint assembly coupled to the arm base assembly; an upper arm assembly coupled to the should joint assembly; an elbow joint assembly coupled to the upper arm assembly; a lower arm assembly coupled to the elbow joint assembly; a wrist joint assembly coupled to the lower arm assembly; and a gripper assembly coupled to the wrist joint assembly. The mast assembly may be coupled to the arm base assembly of the robotic arm subsystem.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is an isometric view of a self-contained robotic arm system according to an embodiment of the present disclosure;

FIG. 2 is another isometric view of a self-contained robotic arm system according to an embodiment of the present disclosure;

FIG. 3 is another isometric view of a self-contained robotic arm system according to an embodiment of the present disclosure;

FIGS. 4-9 are isometric view of a self-contained robotic arm system according to an embodiment of the present disclosure; and

FIGS. 9-11 are isometric views of a self-contained robotic arm system according to an embodiment of the present disclosure.

Like reference symbols in the various drawings indicate like elements.

### DETAILED DESCRIPTION OF THE PREFERRED EMBODIMENTS

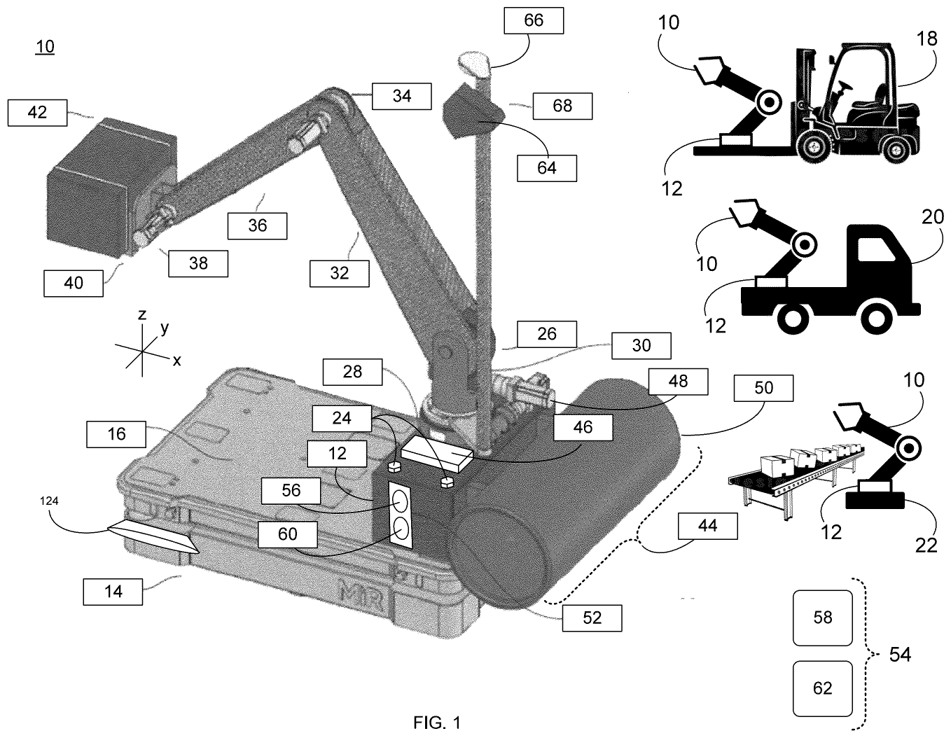

Referring to FIG. 1, there is shown self-contained robotic arm system 10. As will be discussed below in greater detail, self-contained robotic arm system 10 is configured to be self-contained, thus allowing it to be easily moveable from one operating environment to another.

Self-contained robotic arm system 10 may include mounting subsystem 12 configured to releasable engage operating platform 14. For example and as will be discussed below in greater detail, mounting subsystem 12 may be a rigid and compact base that allows for easy attachment to (and detachment from) operating platform 14. Accordingly, mounting subsystem 12 may be constructed of plate steel, may be compact in size, and may be used as a mounting point for all of the systems/subsystems of self-contained robotic arm system 10, thus allowing self-contained robotic arm system 10 to be easily attached to (and detached from) operating platform 14 as a single/solitary unit.

The configuration of operating platform 14 may vary depending upon the operating environment of self-contained robotic arm system 10. For example, operating platform 14 may be a moveable operating platform or a stationary operating platform.

Examples of a moveable operating platform (i.e., operating platform 14) may include but are not limited to: autonomous mobile base 16 (e.g., an intelligent mobile base that is fully (or partially) autonomous and is used within an automated warehouse); a non-autonomous mobile base (e.g., a non-intelligent mobile base that is manually driven/controlled by a user; not shown); forklift 18 (e.g., that is configured to receive self-contained robotic arm system 10); and truck 20 (e.g., that is configured to receive self-contained robotic arm system 10).

An example of a stationary operating platform (i.e., operating platform 14) may include but is not limited to: assembly line stationary base 22 (that is positioned proximate an assembly line).

Mounting subsystem 12 may be configured to releasably engage operating platform 14 with one or more assemblies (e.g., assemblies 24), examples of which may include but are not limited to: one or more releasable fasteners (e.g., nut and bolt assemblies); one or more releasable clamps (e.g., leverage-based clamps); and one or more releasable grasping assemblies (e.g., screw-type clamps). Accordingly and through the use of assemblies 24, mounting subsystem 12 may be quickly and easily detached from operating platform 14. And since (as discussed above) mounting subsystem 12 may be used as a mounting point for all of the systems/subsystems of self-contained robotic arm system 10, self-contained robotic arm system 10 may be easily attached to (and detached from) operating platform 14 as a single/solitary unit.

Detachable, self-contained robotic arm system 10 may include robotic arm subsystem 26 coupled (i.e., directly or indirectly) to mounting subsystem 12. Robotic arm subsystem 26 may include one or more of:
Arm Base Assembly: Arm base assembly 28 may be coupled to mounting subsystem 12 and may be configured to allow self-contained robotic arm system 10 to rotate about the Z-axis with respect to mounting subsystem 12.
Shoulder Joint Assembly: Shoulder joint assembly 30 may be coupled to arm base assembly 28 and may be configured to allow upper arm assembly 32 rotate about the Y-axis with respect to arm base assembly 28. Additionally, shoulder joint assembly 30 may be configured to allow for more complex movements. For example, shoulder joint assembly 30 may also be configured to enable rotation about one or more of the X and Z axes.
Upper Arm Assembly: Upper arm assembly 32 may be coupled to shoulder joint assembly 30 and may be constructed of various materials, such as steel, aluminum, titanium and carbon fiber. Additionally, upper arm assembly 32 may be configured to be longitudinally-extendable along the longitudinal axis of upper arm assembly 32, thus enabling self-contained robotic arm system 10 to have an extended reach when needed.
Elbow Joint Assembly: Elbow joint assembly 34 may be coupled to upper arm assembly 32 and may be configured to allow lower arm assembly 36 to rotate about the Y-axis with respect to upper arm assembly 32. Additionally, elbow joint assembly 34 may be configured to allow for more complex movements. For example, elbow joint assembly 34 may also be configured to enable rotation about one or more of the X and Z axes.
Lower Arm Assembly: Lower arm assembly 36 may be coupled to elbow joint assembly 34 and may be constructed of various materials, such as steel, aluminum, titanium and carbon fiber. Additionally, lower arm assembly 36 may be configured to be longitudinally-extendable along the longitudinal axis of lower arm assembly 36, thus enabling self-contained robotic arm system 10 to have an extended reach when needed.
Wrist Joint Assembly: Wrist joint assembly 38 may be coupled to lower arm assembly 36 and may be configured to allow gripper assembly 40 to rotate about the Y-axis with respect to lower arm assembly 36. Additionally, wrist joint assembly 38 may be configured to allow for more complex movements. For example, wrist joint assembly 38 may also be configured to enable rotation about one or more of the X and Z axes.
Gripper Assembly: Gripper assembly 40 may be coupled to wrist joint assembly 38 and may be configured to grasp various objects. For example, gripper assembly 40 may include a pair of forks (not shown) for releasably engaging and lifting a pallet. Additionally/alternatively, gripper assembly 40 may include a pair of tongs (not shown) for releasably grasping individual items (e.g., boxes, cartons, assemblies). Additionally/alternatively, gripper assembly 40 may include one or more suctions devices (e.g., suction cups; not shown) for generating a vacuum to releasably grasp individual items having a smooth surface upon which a vacuum may be drawn (e.g., boxes, cartons).

Accordingly and depending upon the manner in which gripper assembly 40 is configured, robotic arm subsystem 26 may be configured to grasp various objects (generally represented as object 42), wherein examples of object 42 may include but are not limited to assemblies, discrete items, boxed discrete items, cartons of boxed items, and loaded pallets.

Detachable, self-contained robotic arm system 10 may include control subsystem 44 coupled (i.e., directly or indirectly) to mounting subsystem 12 and configured to effectuate movement of robotic arm assembly 10. Depending upon the manner in which self-contained robotic arm system 10 is configured, control subsystem 44 may include one or more of: a pneumatic control subsystem; an electric control subsystem; and a hydraulic control subsystem.

For example, control subsystem 44 may include a pneumatic control subsystem when it is desired for robotic arm subsystem 26 to effectuate rapid movement (as pneumatic actuators tend to respond more quickly than electric and hydraulic actuators). Further, control subsystem 44 may include an electric control subsystem when it is desired for robotic arm subsystem 26 to effectuate highly-accurate movement (as electric actuators tend to be more accurate and precise than pneumatic and hydraulic actuators). Additionally, control subsystem 44 may include a hydraulic control subsystem when it is desired for robotic arm subsystem 26 to effectuate high-capacity movement (as hydraulic actuators tend to have higher lift capacity than electric and pneumatic actuators).

Naturally, the configuration of control subsystem 44 may vary depending upon the manner in which control subsystem 44 is configured, as discussed below:
If control subsystem 44 includes a pneumatic control subsystem configured for pneumatic actuation, control subsystem 44 may include one or more of: pneumatic controls (generally represented as controls 46); one or more pneumatic actuators (generally represented as joint assemblies 30, 34, 38 and any longitudinally-extendable actuators (not shown) within arms assemblies 32, 36); air compressor (generally represented as pump 48); and air storage tank (generally represented as tank 50).
If control subsystem 44 includes an electric control subsystem configured for electric actuation, control subsystem 44 may include one or more of: electronic controls (generally represented as controls 46); and one or more electronic actuators (generally represented as joint assemblies 30, 34, 38 and any longitudinally-extendable actuators (not shown) within arms assemblies 32, 36).
If control subsystem 44 includes a hydraulic control subsystem configured for hydraulic actuation, control subsystem 44 may include one or more of: hydraulic controls (generally represented as controls 46); one or more hydraulic actuators (generally represented as joint assemblies 30, 34, 38 and any longitudinally-extendable actuators (not shown) within arms assemblies 32, 36); hydraulic pump (generally represented as pump 48); and hydraulic fluid storage tank (generally represented as tank 50).

As discussed above, mounting subsystem 12 may be used as a mounting point for all of the systems/subsystems of self-contained robotic arm system 10, thus allowing self-contained robotic arm system 10 to be easily attached to (and detached from) operating platform 14 as a single/solitary unit. Accordingly, self-contained robotic arm system 10 may include connectivity subsystem 52 coupled (i.e., directly or indirectly) to mounting subsystem 12 and configured to detachably couple self-contained robotic arm system 10 to one or more external systems 54.

For example, connectivity subsystem 52 may include data connectivity subsystem 56 configured to effectuate communication between self-contained robotic arm system 10 and an external control device 58. Examples of data connectivity subsystem 56 may include but are not limited to a hardwired network connection (e.g., an ethernet connection) and a wireless network connection (e.g., a WiFi connection or a Bluetooth connection). Examples of external control device 58 may include but are not limited to an operator control panel, a personal computer, a laptop computer, a tablet computer, and a smart phone.

Further, connectivity subsystem 52 may include power connectivity subsystem configured to provide external power 62 to self-contained robotic arm system 10. Examples of power connectivity subsystem 60 may include but are not limited to a socket assembly configured to provide power to self-contained robotic arm system 10. Examples of external power 62 may include power that is provided by a cable coupled to a power source (e.g., an electrical outlet or a breaker panel).

Detachable, self-contained robotic arm system 10 may include machine vision system 64 configured to enable a user (not shown) of self-contained robotic arm system 10 to visually monitor areas proximate self-contained robotic arm system 10. Examples of machine vision system 64 may include any currently available machine vision systems, such a visible light system, UV/IR systems, LIDAR systems, RADAR systems, and thermal imaging systems.

Additionally/alternatively, vision system 64 may be configured to provide collision avoidance of robotic arm subsystem 26 with proximate people and/or objects. Additionally/alternatively, vision system 64 may be configured to provide proximity detection for safety purposes to e.g., slow down, redirect and/or stop the movement of robotic arm subsystem 26 when a person or object is proximate the moving pieces of robotic arm subsystem 26 and/or its payload. Such a collision avoidance and/or proximity detection system may be configured to augment the existing proximity sensors on operating platform 14 to which self-contained robotic arm system 10 is releasably attached.

Detachable, self-contained robotic arm system 10 may include audio system 66 configured to enable a user (not shown) of self-contained robotic arm system 10 to audibly monitor areas proximate self-contained robotic arm system 10. Examples of audio system 66 may include any currently available microphone systems, such a discrete microphones and/or microphone arrays.

To properly position machine vision system 64 and/or audio system 66 with respect to self-contained robotic arm system 10, machine vision system 64 and/or audio system 66 may be mounted on mast assembly 68 coupled (i.e., directly or indirectly) to mounting subsystem 12. Through the use of mast assembly 68, an elevated point of view may be achieved with respect to the moving parts of self-contained robotic arm system 10, thus providing situational awareness to avoid collision and/or permit safe operation by humans within the reachable proximity of the moving parts of self-contained robotic arm system 10 and/or its payload.

Machine vision system 64 may be configured to include multiple/additional machine vision systems (e.g., multiple/additional cameras). Accordingly, one or more additional cameras may be positioned along robotic arm subsystem 26. For example, these additional cameras may be mounted on robotic arm subsystem 26 and may provide visual target identification for object pick-up and/or positioning, as well as proximate object detection to allow for safe operation of robotic arm subsystem 26 near moving and stationary objects. An example of such a machine vision system may include but is not limited to the Intel® RealSense™ D435 depth camera.

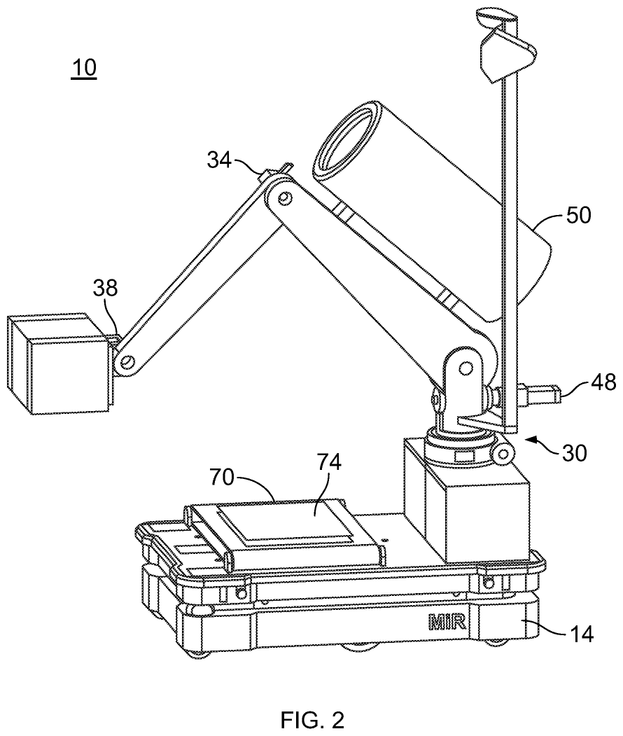

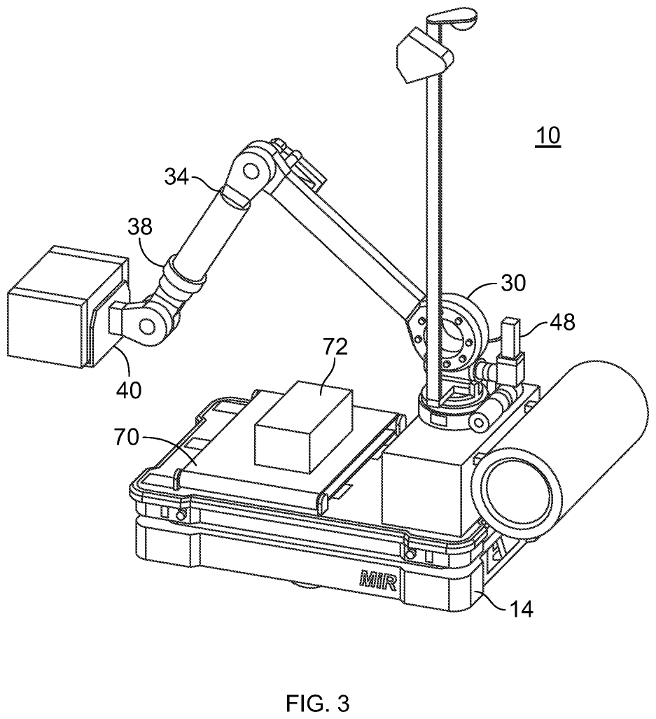

Referring also to FIG. 2-3, self-contained robotic arm system 10 may be configured to enable easier offloading of objects (e.g., object 72) from operating platform 14. For example, self-contained robotic arm system 10 may include conveyor system 70, wherein conveyor system 70 may be configured to receive objects from and/or provide objects to robotic arm subsystem 10.

For example, as self-contained robotic arm system 10 retrieves objects (e.g., object 72), these objects (e.g., object 72) may be placed onto conveyor system 70, wherein operating platform 14 (e.g., when configured as a mobile base) may navigate to an unloading platform (not shown) that may be configured as e.g., a shelf, a slide or another conveyor belt), thus allowing conveyor system 70 to transfer these objects (e.g., object 72) to the unloading platform (not shown). Further, conveyor system 10 may be configured to receive pallets (e.g., pallet 74), wherein self-contained robotic arm system 10 may retrieve objects (e.g., object 72) that are placed onto pallet 74. Once pallet 74 is fully loaded, pallet 74 may be offloaded from operating platform 14 via conveyor system 70. In such a configuration, the unloading platform (not shown) may be an automated wrapping station (not shown) configured to e.g., shrink wrap pallet 74 and the objects positioned thereon.

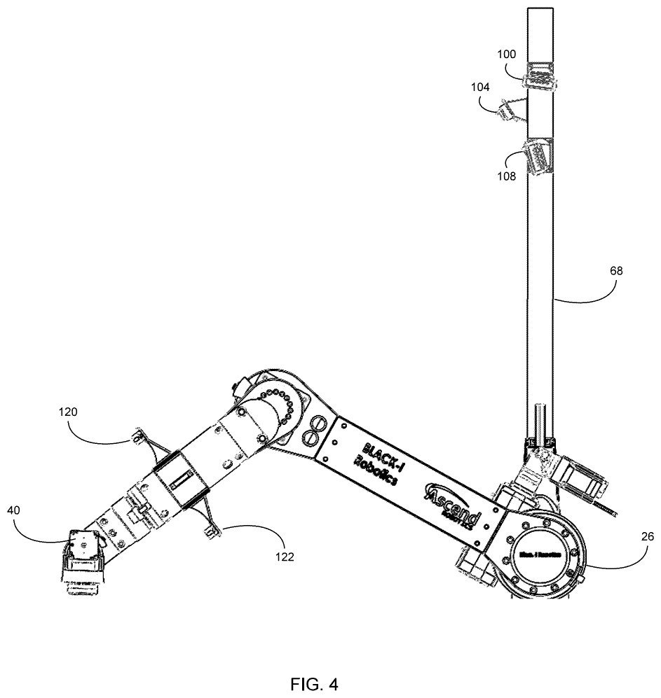

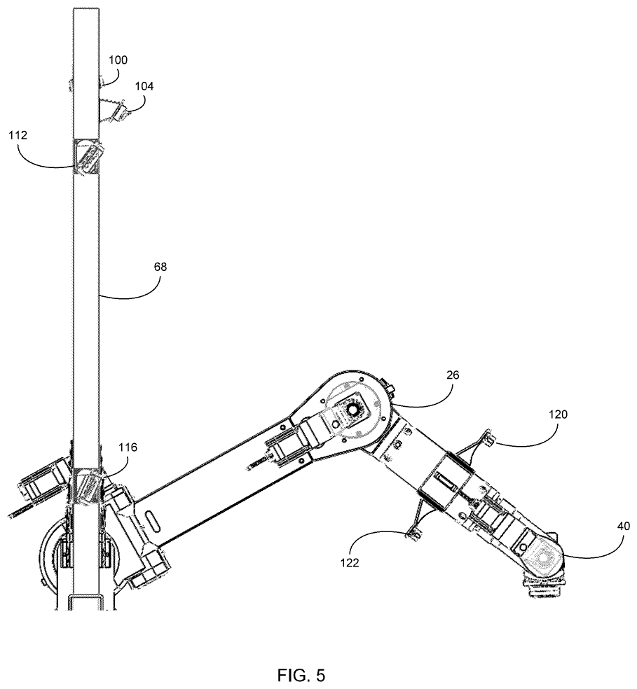

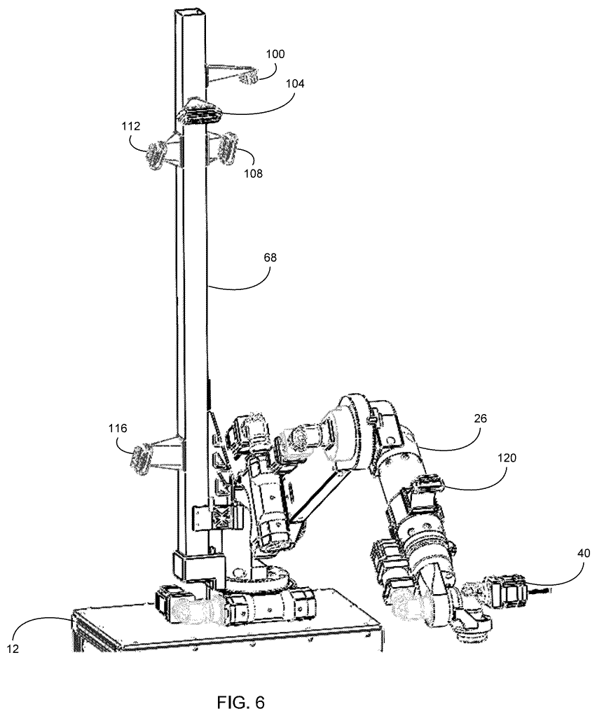

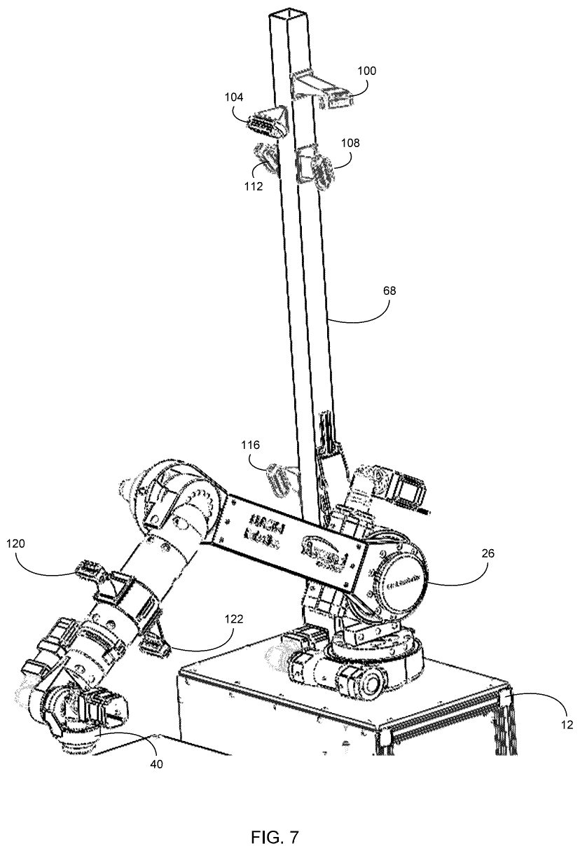

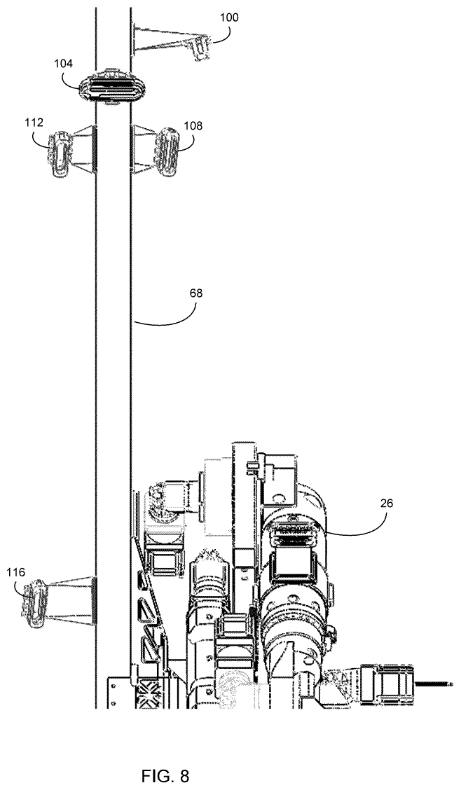

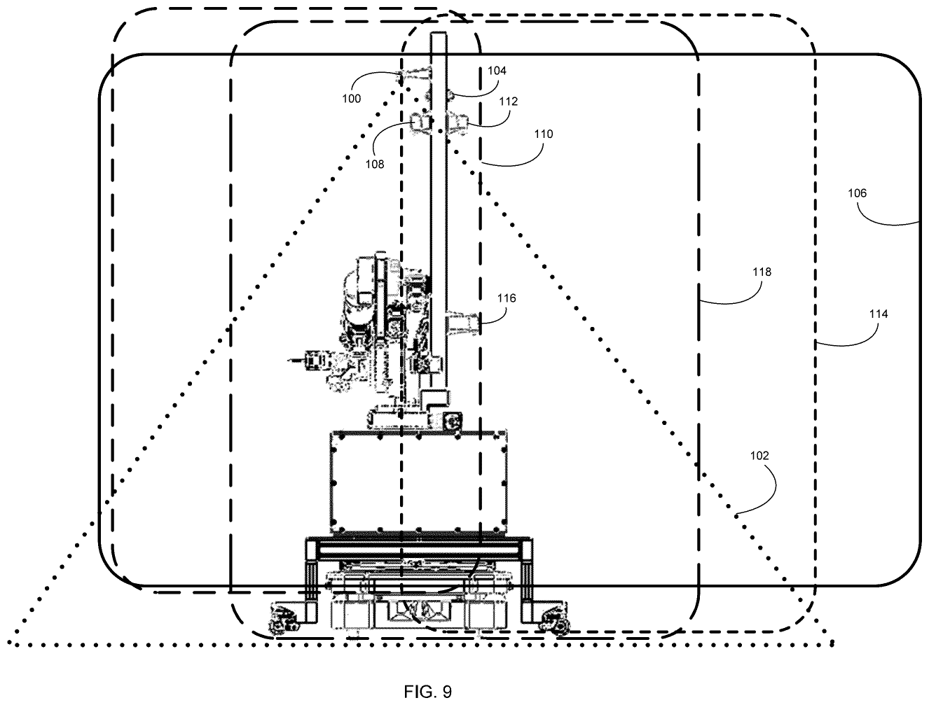

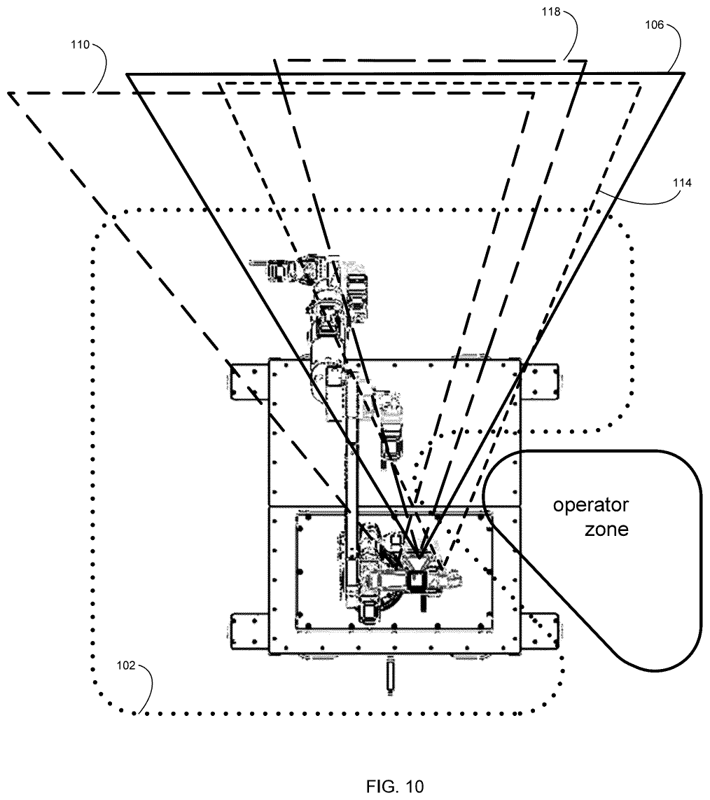

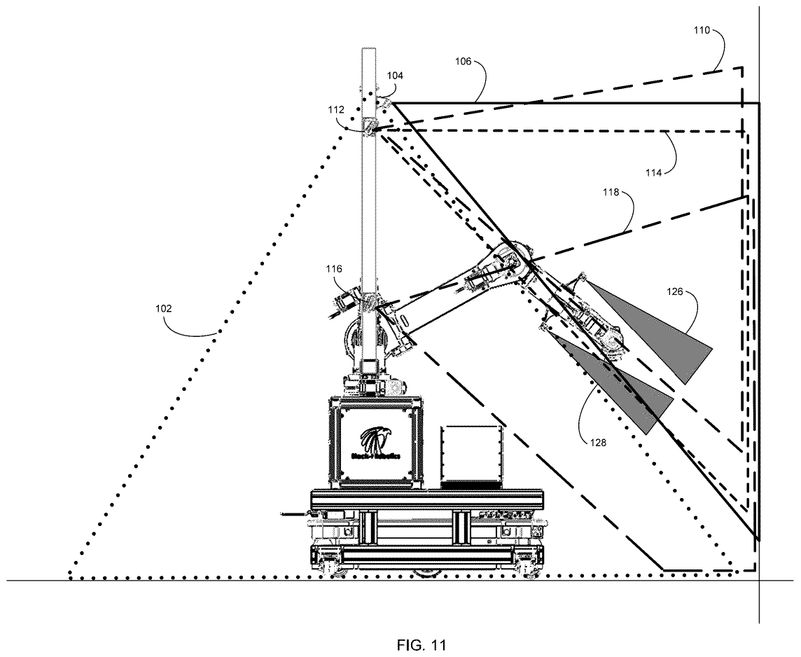

Referring also to FIGS. 4-8, machine vision system 64 may include a plurality of discrete machine vision cameras configured to provide a plurality of discrete machine vision fields of view. For example and in one particular implementation of machine vision system 64, machine vision system 64 may include five discrete machines vision cameras, namely:
“Home View” machine vision camera 100 configured to provide “Home View” machine vision field of view 102 (shown in FIGS. 9-11);
“Main View” machine vision camera 104 configured to provide “Main View” machine vision field of view 106 (shown in FIGS. 9-11);
“Port View” machine vision camera 108 configured to provide “Port View” machine vision field of view 110 (shown in FIGS. 9-11);
“Starboard view” machine vision camera 112 configured to provide “Starboard View” machine vision field of view 114 (shown in FIGS. 9-11); and
“Mid View” machine vision camera 116 configured to provide “Mid View” machine vision field of view 118 (shown in FIGS. 9-11).

At least of portion of the plurality of discrete machine vision fields of view (e.g., fields of view 102, 106, 110, 114, 118) may be configured to overlap to reduce/eliminate blind spots proximate the self-contained robotic arm system (e.g., self-contained robotic arm system 10).

Examples of such discrete machine vision cameras (e.g., cameras 100, 104, 108, 112, 114) may include but are not limited to Intel™ 435 machine vision cameras, Intel D455 and Intel™ D4557 machine vision cameras. These discrete machine vision cameras (e.g., cameras 100, 104, 108, 112, 114) may be mounted to a mast assembly (e.g., mast assembly 68) coupled to and configured to rotate with the robotic arm subsystem (e.g., robotic arm subsystem 26). Mast assembly 68 may be substantially tall and may be constructed of square or round tubing. Mast assembly 68 may include a damper assembly (not shown) to eliminate/minimize vibration of mast assembly 68. Mast assembly 68 may be coupled to arm base assembly 28 of robotic arm subsystem 26 to allow rotation with robotic arm subsystem 26.

Benefits of such a configuration may include but are not limited to:
Positioning mast assembly 68 at an offset in the Y-axis from the base of robotic arm subsystem 26 allows for more accurate depth perception;
Placing mast assembly 68 to swivel at arm base assembly 28 allows for mast assembly 68 to monitor the arm's working envelope with multiple camera angles to create a redundant vision envelope covering the arm's working envelope and possibly the arm itself;
Self-contained robotic arm system 10 has three levels of safety starting with LIDAR system 124 that enables self-contained robotic arm system 10 to “see” everything at floor level out to approximately 30 meters. Further, mast assembly 68 may “see” all objects within 4 meters of self-contained robotic arm system 10 with a focus on the working area envelope. Additionally, self-contained robotic arm system 10 may use current sensing with respect to electric actuators within robotic arm subsystem 26 to monitor for collisions by sensing a spike in current/torque;
As shown in FIGS. 9-11, each of the cameras (e.g., cameras 100, 104, 108, 112, 114) may cover a unique aspect of the vision envelope; and
Each camera (e.g., cameras 100, 104, 108, 112, 114) may individually but certainly in aggregate adhere to the ANSI/RIA R15.08-1-2020 standard to ensure that self-contained robotic arm system 10 can safely operate around humans.

One or more additional machine vision cameras (e.g., cameras 120, 122) may be included within machine vision system 64. These additional machine vision cameras (e.g., cameras 120, 122) may be mounted to a portion of robotic arm subsystem 26 and have fields of view 126, 128. For example, cameras 120, 122 may be mounted proximate to gripper assembly 40, thus enabling a user (not shown) of self-contained robotic arm system 10 to have a field of view proximate to gripper assembly 40. Placing cameras further out on the arm can improve the field of view in the working area and can reduce errors in object detection and localization by having cameras closer to the gripper than the other cameras in machine vision system 64.

As discussed above, machine vision system 64 may include a LIDAR system (e.g., LIDAR system 124). As is known in the art, LIDAR (i.e., Light Detection and Ranging) is a remote sensing technology that uses laser light to measure distances and create detailed 3D maps of objects and environments. It works by emitting a laser pulse and measuring the time it takes for the pulse to bounce back after hitting an object, allowing it to calculate the distance to the object. LIDAR can be used in a variety of applications, including self-driving cars, robotics, mapping, surveying, and more.

While LIDAR system 124 is shown being coupled to autonomous mobile base 16, this is for illustrative purposes only and is not intended to be a limitation of this disclosure, as other configurations are possible and are considered to be within the scope of this disclosure. For example, LIDAR system 124 may be mounted to mast assembly 68 or mounting subsystem 12. LIDAR system 124 is likely to have a field of view that extends around the robot arm and chassis outward often 30 meters or more. But that field of view is often planar and narrow so one embodiment is to use the LDAR system 124 to detect moving objects at greater distance than the working zone of the arm, provide an early warning to the robot that a person or moving object is approaching the robot arm's work area. This allows the mechanism to slow, avoid or stop at a predetermined range from the working zone of the arm. In this way a layered perimeter defense can be established; the LIDAR providing long-range detection and the cameras of machine vision system 64 providing working area obstacle detection and collision avoidance.

Audio system 66 may be coupled to the mast assembly (e.g., mast assembly 68) and may be configured to enable a user (not shown) of self-contained robotic arm system to audibly monitor areas proximate self-contained robotic arm system 10.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A self-contained robotic arm system comprising:
an operating platform;
a robotic arm subsystem coupled to the operating platform;
a control subsystem coupled to the operating platform and configured to effectuate movement of the robotic arm assembly;
a mast assembly coupled to and configured to rotate with the robotic arm subsystem; and
a machine vision system coupled to the mast assembly and configured to enable a user of the self-contained robotic arm system to visually monitor areas proximate the self-contained robotic arm system.

2. The self-contained robotic arm system of claim 1 wherein the machine vision system includes:
a LIDAR system; and
a plurality of discrete machine vision cameras configured to provide a plurality of discrete machine vision fields of view.

3. The self-contained robotic arm system of claim 2 wherein at least of portion of the plurality of discrete machine vision fields of view are configured to overlap to reduce/eliminate blind spots proximate the self-contained robotic arm system.

4. The self-contained robotic arm system of claim 1 further comprising:
an audio system coupled to the mast assembly and configured to enable a user of the self-contained robotic arm system to audibly monitor areas proximate the self-contained robotic arm system.

5. The self-contained robotic arm system of claim 1 wherein the control subsystem includes one or more of:
a pneumatic control subsystem;
a electric control subsystem; and
a hydraulic control subsystem.

6. The self-contained robotic arm system of claim 5 wherein the pneumatic control subsystem includes one or more of:
pneumatic controls;
one or more pneumatic actuators;
an air compressor; and
an air storage tank.

7. The self-contained robotic arm system of claim 5 wherein the electric control subsystem includes one or more of:
electronic controls; and
one or more electronic actuators.

8. The self-contained robotic arm system of claim 5 wherein the hydraulic control subsystem includes one or more of:
hydraulic controls;
one or more hydraulic actuators;
a hydraulic pump; and
a hydraulic fluid storage tank.

9. The self-contained robotic arm system of claim 1 wherein the robotic arm subsystem includes one or more of:
an arm base assembly;
a shoulder joint assembly coupled to the arm base assembly;
an upper arm assembly coupled to the should joint assembly;
an elbow joint assembly coupled to the upper arm assembly;
a lower arm assembly coupled to the elbow joint assembly;
a wrist joint assembly coupled to the lower arm assembly; and
a gripper assembly coupled to the wrist joint assembly.

10. The self-contained robotic arm system of claim 9 wherein the mast assembly is coupled to the arm base assembly of the robotic arm subsystem.

11. The self-contained robotic arm system of claim 9 wherein the shoulder joint assembly is configured to enable rotation about one or more of the X, Y and Z axis.

12. The self-contained robotic arm system of claim 9 wherein the elbow joint assembly is configured to enable rotation about one or more of the X, Y and Z axis.

13. The self-contained robotic arm system of claim 9 wherein the wrist joint assembly is configured to enable rotation about one or more of the X, Y and Z axis.

14. The self-contained robotic arm system of claim 1 wherein the operating platform is a moveable operating platform.

15. The self-contained robotic arm system of claim 14 wherein the moveable operating platform includes one or more of:
an autonomous mobile base;
a non-autonomous mobile base;
a forklift; and
a truck.

16. A self-contained robotic arm system comprising:
an operating platform;
a robotic arm subsystem coupled to the operating platform;
a control subsystem coupled to the operating platform and configured to effectuate movement of the robotic arm assembly;
a mast assembly coupled to and configured to rotate with the robotic arm subsystem; and
a machine vision system coupled to the mast assembly and configured to enable a user of the self-contained robotic arm system to visually monitor areas proximate the self-contained robotic arm system, wherein the machine vision system includes:
a plurality of discrete machine vision cameras configured to provide a plurality of discrete machine vision fields of view.

17. The self-contained robotic arm system of claim 16 wherein the machine vision system further includes:
a LIDAR system.

18. The self-contained robotic arm system of claim 16 wherein at least of portion of the plurality of discrete machine vision fields of view are configured to overlap to reduce/eliminate blind spots proximate the self-contained robotic arm system.

19. The self-contained robotic arm system of claim 16 further comprising:
an audio system coupled to the mast assembly and configured to enable a user of the self-contained robotic arm system to audibly monitor areas proximate the self-contained robotic arm system.

20. The self-contained robotic arm system of claim 16 wherein the robotic arm subsystem includes one or more of:
an arm base assembly;
a shoulder joint assembly coupled to the arm base assembly;
an upper arm assembly coupled to the should joint assembly;
an elbow joint assembly coupled to the upper arm assembly;
a lower arm assembly coupled to the elbow joint assembly;
a wrist joint assembly coupled to the lower arm assembly; and
a gripper assembly coupled to the wrist joint assembly.

21. The self-contained robotic arm system of claim 20 wherein the mast assembly is coupled to the arm base assembly of the robotic arm subsystem.

22. A self-contained robotic arm system comprising:
an operating platform;
a robotic arm subsystem coupled to the operating platform;
a control subsystem coupled to the operating platform and configured to effectuate movement of the robotic arm assembly;
a mast assembly coupled to and configured to rotate with the robotic arm subsystem; and
a machine vision system coupled to the mast assembly and configured to enable a user of the self-contained robotic arm system to visually monitor areas proximate the self-contained robotic arm system, wherein the machine vision system includes:
a plurality of discrete machine vision cameras configured to provide a plurality of discrete machine vision fields of view, and
a LIDAR system;
wherein at least of portion of the plurality of discrete machine vision fields of view are configured to overlap to reduce/eliminate blind spots proximate the self-contained robotic arm system.

23. The self-contained robotic arm system of claim 22 further comprising:
an audio system coupled to the mast assembly and configured to enable a user of the self-contained robotic arm system to audibly monitor areas proximate the self-contained robotic arm system.

24. The self-contained robotic arm system of claim 22 wherein the robotic arm subsystem includes one or more of:
an arm base assembly;
a shoulder joint assembly coupled to the arm base assembly;
an upper arm assembly coupled to the should joint assembly;
an elbow joint assembly coupled to the upper arm assembly;
a lower arm assembly coupled to the elbow joint assembly;
a wrist joint assembly coupled to the lower arm assembly; and
a gripper assembly coupled to the wrist joint assembly.

25. The self-contained robotic arm system of claim 22 wherein the mast assembly is coupled to the arm base assembly of the robotic arm subsystem.
